(19) United States
(12) Patent Application Publication
(10) Pub. No.: US 2015/0106134 A1
(43) Pub. Date: Apr. 16, 2015

(54) SYSTEMS AND METHODS FOR GROUPED SEAT SELECTION

(71) Applicants: Satya Gandham, Fremont, CA (US); Nikhil Sukhtankar, Fremont, CA (US)

(72) Inventors: Satya Gandham, Fremont, CA (US); Nikhil Sukhtankar, Fremont, CA (US)

(21) Appl. No.: 14/055,750

(22) Filed: Oct. 16, 2013

(51) Int. Cl. G06Q 10/02

(52) U.S. Cl. CPC G06Q 10/02
USPC 705/5

(57) ABSTRACT

Computing systems and methods for facilitating the selection and purchase of tickets for grouped seats for an event at a venue are provided. The grouped seats may include groups of seats in a piggyback configuration. The piggyback configuration may include at least one seat in each of multiple adjacent seat rows. The system may provide a user with a seat group filter option and receive a request for piggyback seats through the provided seat group filter option. The system may display a map and a list of available tickets for the event. The map may be updated in response to a user request for piggyback-only seat options. The updated map may highlight sections of seats that include available seats that match the requested piggyback configuration.

### BACKGROUND

1. Technical Field

The present disclosure relates generally to electronic commerce, and more particularly, to the presentation of grouped seating arrangements associated with automated ticket purchase transactions.

2. Related Art

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics.

One example of a market for goods within the realm of electronic commerce is the online ticket market. Various online ticket sellers provide websites through which parties can buy and sell tickets online. These tickets can be for a variety of live events, such as sporting events, concerts, theater events, and other entertainment events. Typically, a buyer looks for available tickets on a ticket marketplace website or other online listing and decides which, if any, of the available tickets are of interest to the buyer for possible purchase.

Groups of available tickets are often located in a common row of seats. In some situations, it may not be desirable to a potential buyer to purchase a large number of tickets in the same row. For example, it can be difficult to communicate with a friend sitting several seats away along a row during an event. However, particularly when tickets are offered for sale from multiple ticket owners at a ticket resale vendor website, it can be difficult for a potential purchaser to determine whether other seat groupings are available for purchase.

It may therefore be desirable to provide systems and methods for allowing potential ticket purchasers to select and purchase tickets for customized groups of seats for various ticketed events.

### BRIEF DESCRIPTION OF THE DRAWINGS

FIG. 1 is a block diagram of an illustrative computing system that is adapted for implementing the selection and purchase of grouped tickets for ticketed events according to an embodiment.

FIG. 2 is a block diagram of an illustrative computer system suitable for implementing on one or more devices of the computing system in FIG. 1 according to an embodiment.

FIG. 3 is a block diagram of an illustrative system for providing grouped seat selection and purchase according to an embodiment.

FIG. 4 is a diagram of an illustrative service provider web page showing how a user may be provided with filtering options according to an embodiment.

FIG. 5 is an illustrative portion of a seat map showing how various seat group configurations may be presented to a user according to an embodiment.

FIG. 6 is a flowchart showing an illustrative process that may be performed by a ticket provider for grouped seat selection and purchase according to an embodiment.

FIG. 7 is an illustrative seat grouping filter option having a selectable piggyback-only seat configuration filter according to an embodiment.

FIG. 8 is an illustrative seat grouping filter option having a drop-down list for inputting a maximum number of seats per row in a group of seats according to an embodiment.

FIG. 9 is a flowchart showing another illustrative process that may be performed by a ticket provider for grouped seat selection and purchase according to an embodiment.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

Devices, systems and methods are provided for performing activities related to the online purchase of tickets to ticketed events. In various particular embodiments, the devices, systems or methods can involve one or more devices in communication over a network. Such devices, systems, and methods can facilitate the selection and purchase of grouped tickets to various ticketed events. The grouped tickets may be for groups of seats at an event that are arranged in a user preferred configuration such as a piggyback configuration (e.g., a configuration in which some seats in the group are located in a first row of seats and other seats in the group are located in a second row of seats that is behind or in front of the first row of seats).

For example, a group of four people may prefer to obtain seats at an event that are arranged in a piggyback configuration in which one group of two sits directly behind another group of two. Larger groups may also prefer to sit in customized groupings of seats that facilitate interaction between group members during an event. As another example, a group of five people may wish to sit with three people in front of (or behind) two people. In this way, a group of people may be able to sit in a grouped configuration that prevents one member of the group from sitting undesirably far from another member of the group (e.g., along a common row).

While the various examples disclosed herein focus on particular aspects regarding the purchase of tickets, it will be understood that the various inventive principles and embodiments disclosed herein can be applied to other types of ticketed applications and arrangements as well. For example, a ticket purchase that is performed in person or on a closed or proprietary computing system may utilize one or more of the aspects and features found in the various systems and methods provided.

Reference throughout the specification to “various embodiments,” “some embodiments,” “one embodiment,” “an embodiment,” “various examples,” “one example,” “an example,” or “some examples” means that a particular feature, structure, or characteristic described in connection with the embodiment or example is included in at least one embodiment. Thus, appearances of these are not necessarily all referring to the same embodiment. Furthermore, the particular features, structures or characteristics may be combined in any suitable manner in one or more embodiments.

According to an embodiment, a computer program product can comprise a non-transitory machine readable medium. The non-transitory machine readable medium can have computer readable and executable code for instructing one or more processors to perform any of the methods disclosed herein.

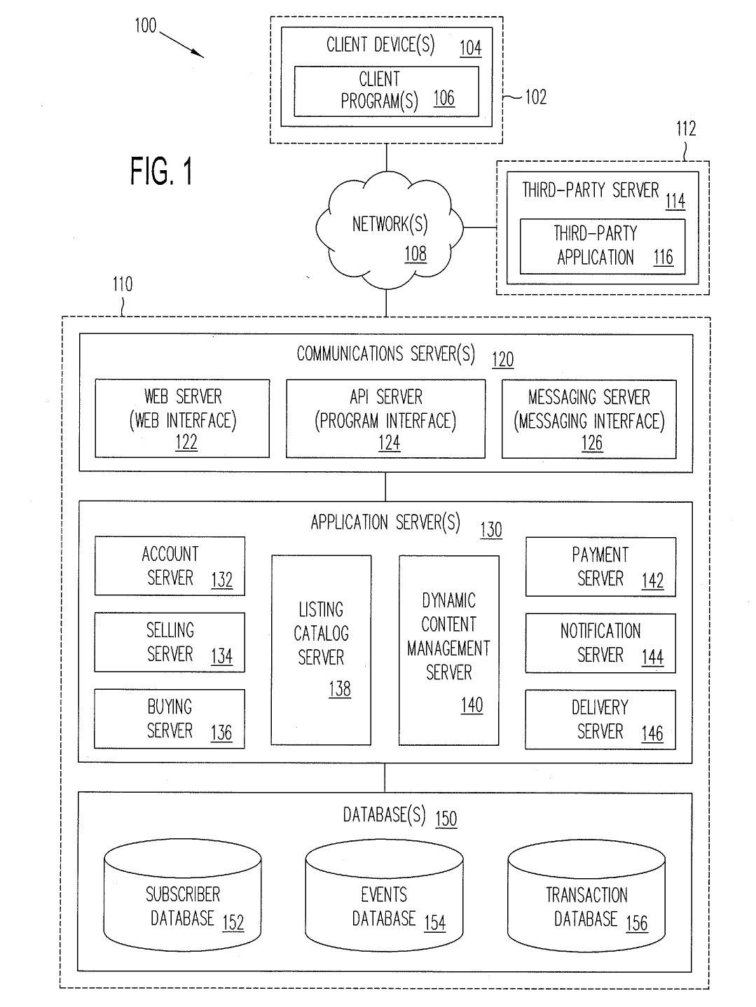

Beginning with FIG. 1, an exemplary embodiment of a computing system adapted for implementing the selection and purchase of grouped tickets for ticketed events is illustrated in block diagram format. As shown, a computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a laptop, a mobile computing device, a PC, and/or any other computing device having computing and/or communications capabilities in accordance with the described embodiments. In particular, it is specifically contemplated that client devices 104 can include a cellular telephone or other similar mobile device that a user can carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 (e.g., a communications session for selection and/or purchase of grouped seats for a ticketed event) may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated. In particular, wireless communications of any suitable form may take place between client 102 and system 110, such as that which often occurs in the case of mobile phones or other personal mobile devices.

In various embodiments, computing system 100 can include, among other elements, a third party 112, which may comprise or employ a third-party server 114 hosting a third-party application 116. In various implementations, third-party server 114 and/or third-party application 116 may host a web site associated with or employed by a third party 112. For example, third-party server 114 and/or third-party application 116 may enable network-based system 110 to provide client 102 with additional services and/or information, such as additional ticket inventory (e.g., ticket inventory that can be provided in customized groups to potential ticket purchasers). In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, and notification services. Application servers 130 may include an account server 132, a selling server 134, a buying server 136, a listing catalog server 138, a dynamic content management server 140, a payment server 142, a notification server 144, and/or a delivery server 146 structured and arranged to provide such online marketplace and ticket fulfillment services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

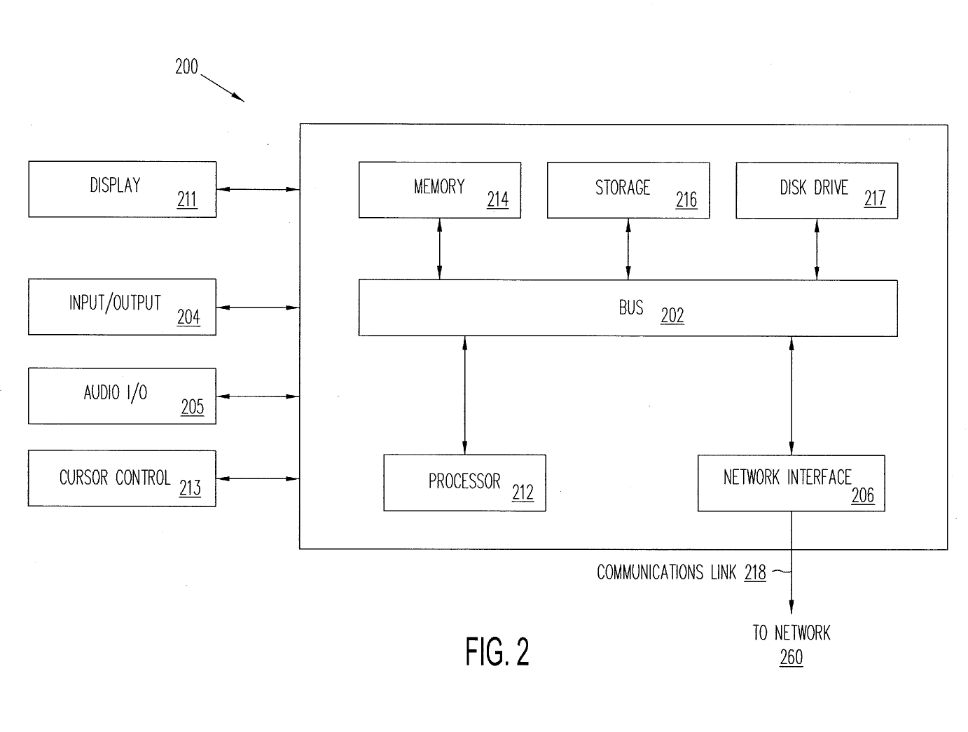

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart or mobile phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, a venue server or a payment provider server via a network. In various embodiments, such as for many cellular telephone and other mobile device embodiments, this transmission can be wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Again, communication link 218 can simply be a wireless communication form in some embodiments. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory machine-readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof can be used to implement a user-configurable grouped ticket selection and purchase operation such as the selection and purchase of various configurations of piggyback sets of seats for events. A piggyback set of seats may, for example, be a group of seats that includes at least one seat in multiple adjacent rows of seats. While embodiments described herein refer to piggybacked seats, other seat groupings may also be applicable. For example, a user may desire one set of seats in one section and another set of seats in another section.

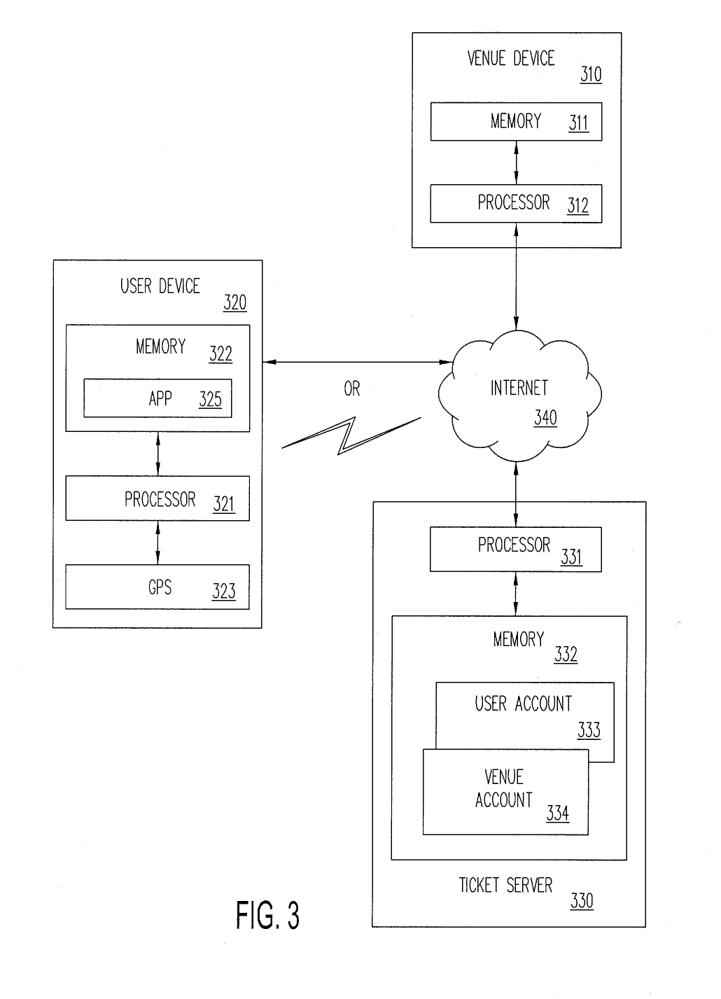

FIG. 3 is a block diagram showing a grouped seat selection and purchase system, according to an embodiment. A venue device such as a venue device 310 can be present at each of a plurality of different event venues (e.g., stadiums, theaters, arenas, amphitheaters, or other venues at which ticketed events are held). Venue device 310 can provide information regarding events scheduled to occur at a particular venue and regarding seating at that venue. Venue device 310 can provide the information to a ticker server 330. Ticket server 330 can obtain information regarding events scheduled to occur at various venues and information regarding seating at the various venues. Ticket server 330 may, for example, be an implementation of system 110 of FIG. 1.

Venue device 310 can be a computer, a server, a computing tablet, or a mobile device, as examples. Venue device 310 can have processing circuitry such as processor 312 and storage such as memory 311. Processor 312 can execute a software program stored in memory 311 for providing information regarding events scheduled to be at the venue and regarding seating at the venue for each scheduled event. Venue device 310 can provide the information to the ticket server and/or to a user device such as user device 320.

Venue device 310 can be disposed at the venue. However, this is merely illustrative. If desired, venue device 310 can be disposed at a location other than the venue. Each venue can have a dedicated venue device 310 or a plurality of different venues can share a common venue device 310. For example, co-owned venues can share a common venue device 310. In one embodiment, venue device 310 can be omitted if ticket server 330 has the information needed buy and sell tickets. For example, ticket server 330 may have a database of available tickets and information about the tickets and venues to enable ticket server 330 to provide the necessary information to a user for purchasing tickets to events at venues.

A user (e.g., a potential ticket purchaser) can use a device such as a user device 320 to shop online for available tickets or groups of tickets for one or more events. User device 320 can be a mobile device such as a cellular telephone, a tablet computer, a laptop computer, or another portable computing device. User device 320 can be a non-mobile device such as a home (land line) telephone, a desktop computer, an interactive set top box, or the like. User device 320 can be any device or combination of devices that facilitate online ticket purchasing. User device 320 may, for example, be an implementation of client device 104 of FIG. 1.

User device 320 can have a processor 321, a memory 322, a global positioning system (GPS) 323 and/or other suitable device components. Processor 321 can execute an application such as an app 325 that facilitates the grouped seat selection method disclosed herein. App 325 can be stored in memory 322. App 325 can provide a graphical user interface (GUI) for the user when the user is selecting and purchasing tickets online. If desired, app 325 can be a dedicated ticket purchasing app. However, this is merely illustrative. In some configurations, app 325 can be part of another app, such as a Paypal, Inc. payment provider app.

User device 320 can communicate with venue device 310 and/or ticket server 330 via a network. For example, user device 320 can communicate with venue device 310 and/or ticket server 330 via the Internet 340. User device 320 can communicate with the Internet via either a wired connection or a wireless connection.

Ticket server 330 may be operated by an online ticket seller such as StubHub, Inc. Ticket server 330 can facilitate online ticket sales. Ticket server 330 may include processing circuitry such as processor a 331 in communication with storage such as a memory 332. Processor 331 can include one or more processors. Processor 331 can access accounts such as a user account 333 and/or a venue account 334 that are stored in memory 332. User account 333 can include information regarding the user (e.g., identification information, preferences, account numbers, and purchase history). Venue account 334 can include information regarding the venue (e.g., information regarding events, seating, and other venue features). Memory 332 can be separate from the ticker server and can be used to store any number of user accounts 333 and venue accounts 334. Memory 332 can be distributed, e.g., have portions thereof disposed at a plurality of different locations. Other accounts may also be accessible by processor 331, such as accounts of users selling tickets that include ticket details, such as price, quantity, location, and event information, and financial information that enables funds to be deposited into seller accounts when their tickets are sold.

Ticket server 330 may include one or more servers located at one or more locations. Thus, the ticket server 330 can be geographically and operationally distributed if desired. Ticket server 330 can be part of another system, such as a payment provider system. Venue device 310 can communicate with ticket server 330 over a wired or wireless connection such as via a network. For example, venue device 310 can communicate with ticket server 330 via Internet 340. Venue device 310 can communicate with a plurality of different ticket servers 330. Ticket server 330 can communicate with a plurality of different the venue devices 310. A plurality of different ticket servers 330 can communicate among themselves and can be considered herein as being the same as a single ticket server 330. The user can operate user device 320 to interact with ticket server 330 so that the user can select and purchase grouped tickets (e.g., sets of tickets for seats in a piggyback configuration) online.

Ticket server 330 can communicate with venue device 310 to obtain information about the venue. For example, ticket server 330 can communicate with venue device 310 to obtain information regarding the scheduling of events at the venue and regarding features of the venue. The features of the venue can be dependent upon the events of the venue, e.g., the features of the venue can vary from event to event. Generally, venue device 310, mobile device 320, and ticket server 330 can perform functions discussed herein. That is, at least to some extent, a function that is discussed herein as being performed via a particular one of these devices can be performed by a different one of these devices, by a combination of these devices, and/or by other devices.

Venue device 310, user device 320, other mobile devices, and server 330 can communicate with one another via a network, such as the Internet 340. Venue device 310, user device 320, other mobile devices, and server 330 can communicate with one another via one or more networks, such as local area networks (LANs), wide area networks (WANs), cellular telephone networks, and the like. Venue device 310, mobile devices such as user device 320, server 330, and other devices (e.g., a social network device) can communicate with one another, at least partially, via one or more near field communications (NFC) methods or other short range communications methods, such as infrared (IR), Bluetooth, WiFi, and WiMax.

When a user wishes to shop for tickets online, the user can open an online ticket seller's website or can access the ticket seller using an application such as app 325. The user can open the ticket seller's website using user device 320, for example. The ticket seller's website can be hosted on ticket server 330, venue device 310, or on any other server or device.

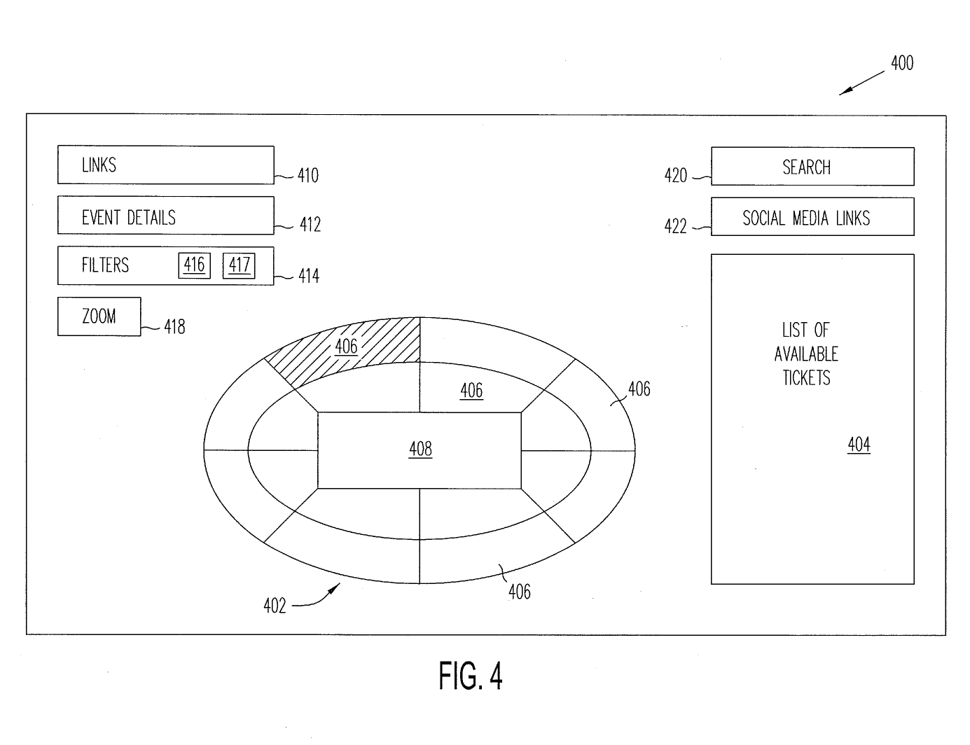

FIG. 4 is a diagram of a ticket seller website that is configured to facilitate selection and purchase of grouped tickets for ticketed events. As shown in FIG. 4, a website such as ticket seller website 400 may include a list such as list 404 of available tickets for an event. The event can be a concert, a sporting event, a user-generated event, or any other type of event for which tickets are sold. Website 400 may be an implementation of web interface 122 of FIG. 1, may be provided to user device 320 by ticket server 330, or may be otherwise provided to or accessed by a potential ticket buyer.

In some embodiments, website 400 may also include map such as venue map 402. Venue map 402 may be an interactive venue map or a non-interactive venue map that shows a seating diagram of a venue for a particular user-selected event. The event can be specified by the user by stating a name of the event, a venue, and/or a date. For example, a concert event for a particular artist at a particular arena on a particular date can be specified by entering the name of the artist, the name of the arena, and/or the date in one or more entry boxes such as search box 420 of website 400.

If the information entered is insufficient to uniquely identify the event, then website 400 can present the user with a list of possible events. For example, if the user only entered an artist name without stating a date or venue, then a list of upcoming concerts (tour dates) for that artist can be presented for the user to choose from. In this way, the user can quickly find the event for which tickets are desired. After the event has been uniquely identified, the user can be presented with map 402 and list 404 for the event.

Map 402 can show seating areas such as sections 406 and their relationship to an attraction area such as area 408 at the venue. Attraction area 408 may be a stage, a game court, or a field (as examples). The ticket prices for each section 406 can also be provided.

As shown in FIG. 4, some sections 406 may be displayed differently from other sections. For example, the cross-hatched section 406 in FIG. 4 may be a color coded section, a cross-hatched section, a grey section or may otherwise be displayed in a way that indicates seat related information to the user. For example, the cross-hatched section may be a section with available tickets, without available tickets, or with available tickets that match user-selected criteria such as ticket grouping criteria.

Map 402 can be interactive. For example, in response to the user scrolling over a portion of list 404 with a cursor or tapping on a particular portion of list 404 using a touch screen, the ticket server can change the marking on the map to indicate, for example, the location in map 402 of seats in list 404 that the user has scrolled over or tapped. However, this is merely illustrative. If desired, map 402 may be a static (non-interactive) map of an event venue or, particularly in the case of user-generated events, website 400 may be provided without a venue map. In situations in which a venue map is unavailable, a potential ticket purchaser may select tickets for purchase from list 404 of available tickets.

Website 400 may also include additional features such as links 410, event details 412, zoom features 418, filters 414, social media links 422 and/or other suitable ticket purchase related features.

Links 410 may include clickable links to other events such as upcoming events at the same venue, sporting events, concerts, theater events, fan services, user account services or other internal or external links.

Event details 412 may include graphical or text representations of the details of the selected event such as the artist name, the venue name, the date of the event, the time of the event, or other event related information.

Social media links 422 may include clickable links that allow a user to share event and/or ticket details with others through various social media servers.

Filters 414 may include a ticket price filter, a ticket quantity filter, a venue zone filter, a ticket delivery method filter, a seat feature filter such as a seat feature filter 416 and/or a ticket grouping filter such as a seat grouping filter 417. Seat feature filter 416 may allow a user to limit the available seats that are displayed to the user based on seat features (e.g., view obstructions, parking privileges associated with the seats, proximity to inter-seat isles or stairways, etc.). If desired, seat grouping filter 417 may be included as a portion of seat feature filter 416 (e.g., as a selectable option under a pull-down menu associated with seat feature filter 416). However, this is merely illustrative. If desired, seat grouping feature 417 may be a standalone filter.

Seat grouping filter 417 may provide the user with the ability to specify a grouping configuration (e.g., to exclude seats that are not piggyback seats by selecting a piggyback-only seat option). When a user selects a desired grouping configuration, list 404 and/or map 402 may be updated in response to the user's selection. For example, sections 406 of map 402 that previously indicated available seats may be displayed differently (e.g., using a different color) if no piggyback seats are available in that section. In another example, list 404 may be updated to display only available tickets that are in a piggyback configuration.

Zoom feature 418 may be a clickable feature that allows the user to zoom into a particular portion of map 402. In this way, a user can view particular section numbers, individual rows of seats in a section, and/or individual seats or groups of seats that are available in a particular section for the selected event.

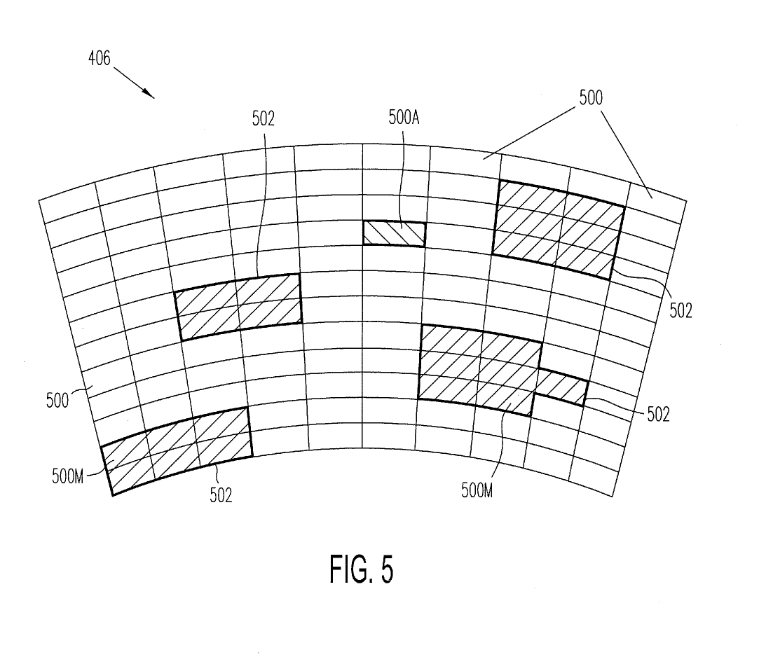

FIG. 5 is a diagram of a representative section 406 of map 402 showing how seat groups such as groups of piggyback seats may be displayed in map 402 on website 400. In situations in which a user has filtered map 402 for piggyback seats, section 406 may include unavailable seats 500 in a first color and available matching seats 500M that are available for purchase and that match the user provided grouping criteria in another color. For example, section 406 may contain one or more groups 502 of matching seats 500M. Matching seats 500M may be piggyback seats from an individual seller or piggyback seats from multiple sellers. Groups 502 may include at least one matching seat 500M in at least two adjacent seat rows.

As shown in FIG. 5, groups 502 may include various numbers of seats 500M in various numbers of rows (e.g., two rows of two seats, two rows of three seats, three rows of two seats, more than three rows of two seats, more than two rows of three seats, or any number of seats in any number of adjacent rows).

If desired, map 402 may show available non-matching seats 500A (e.g., seats that are available for purchase, but do not match the user's selected grouping criteria) in a third color.

If desired, ticket server 330 may be arranged to allow a user to pre-define a preferred seat grouping (e.g., during a user account setup process). This pre-definition of preferred seat grouping can then apply to all subsequently displayed maps. For example, the user can select only groups of seats having a piggyback configuration to be displayed on all future maps. In this way, any maps displayed by the venue seat and feature map in the future can automatically highlight only sections with available seats that match the user's seat grouping configuration preference. Alternatively, ticket server 330 can apply seat grouping preferences based on a user's previous ticket search history.

This type of pre-defined or history-based seat grouping preference can last indefinitely or can last for a pre-determined amount of time. Such customization or pre-definition of seat groupings to be shown on a map can last for a day, a week month, a season, a year, multiple years, or any other length of time.

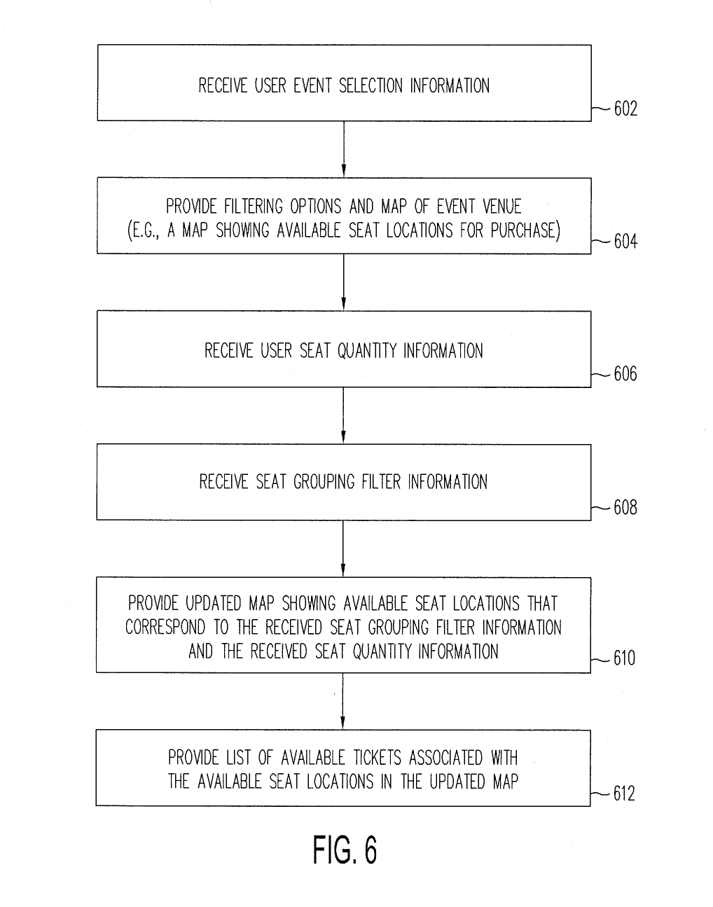

FIG. 6 is a flow chart of illustrative steps that may be used in providing grouped seat selection and purchase services.

At step 602, a ticket provider such as ticket server 330 of FIG. 3 may receive user event selection information from a user device such as user device 320. The received user event selection information may be provided by the user when the user searches for and/or selects a particular event at a ticket server webpage such as website 400 of FIG. 4.

At step 604, the server may provide filtering options and a map of the event venue (e.g., a map such as map 402 of FIG. 4 showing available seat locations for purchase) to the user. Providing the filtering options may include providing a seat grouping filter option, other seat feature filter options, and/or other filtering options as described above in connection with filters 414 of FIG. 4.

At step 606, the server may receive user seat quantity information from the user. The user seat quantity information may be user-provided information that indicates the number of desired seats for the selected event. For example, a user may enter a desired number of seats using a keyboard, a touchscreen, voice or other data input mechanisms, or a user may select a desired number of tickets from a drop-down list of possible seat quantities. The user may also specify a range for the number of seats.

At step 608, the server may receive seat grouping filter information from the user. The seat grouping filter information may be user-provided information that indicates the desired seat grouping configuration for the user (e.g., a user request for seats in a piggyback configuration, a user request for maximum number of seats in a row, etc.). For example, a user may use website 400 to select a piggyback-only option, to enter a maximum number of seats in a given row, to enter a desired number of rows, or to otherwise choose a desired seat group configuration. Other ways to indicate or communicate a desired seat group configuration include drawing the configuration, either on specific areas of the event seating map or in a specifically designated area on the display. For example, the user may draw a rectangle to indicate non-staggered seats in directly adjacent rows.

At step 610, in response to the information received at step 608, the server may provide an updated map to the user showing available seat locations that correspond to the received seat grouping filter information and the received seat quantity information. For example, a map such as map 402 may be redisplayed with highlighted or color-coded sections that include seat groups that correspond to the received seat quantity information and the received seat grouping filter information (e.g., sections that include available groups of seats in a piggyback configuration).

At step 612, the server may provide a list of available tickets associated with the available seat locations in the updated map. If desired, the user can initiate purchase of tickets shown in the provided list or in the updated map by clicking on the available tickets in the provided list.

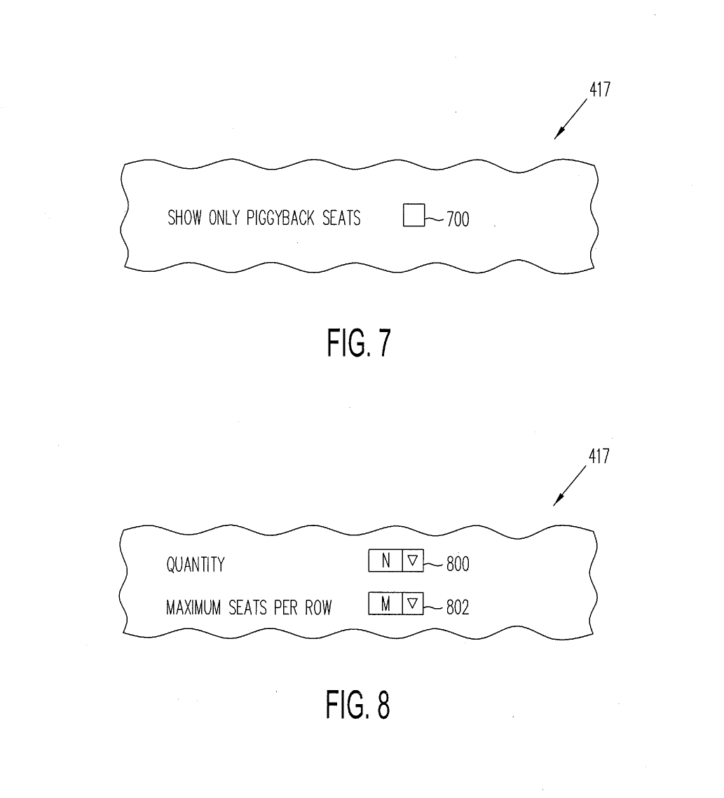

FIGS. 7 and 8 show examples of a portion of a ticket seller website that includes a seat grouping filter such as seat grouping filter 417 that may be used for receiving seat grouping filter information at, for example, step 608 of FIG. 6.

As shown in FIG. 7, seat grouping filter 417 may include a selectable option to show only piggyback seats (sometimes referred to herein as a selectable piggyback-only option or a piggyback-only filter option). A user of website 400 may use a cursor controlled by a mouse, a finger on a touch screen, or other suitable input methods to check a virtual box such as box 700 in order to activate the piggyback-only filter option. This type of selectable seat grouping filter option may be included in a pull-down menu that is displayed when a user views seat feature filter 416 on website 400. However, this is merely illustrative. If desired, a selectable seat grouping feature of the type shown in FIG. 7 may be displayed separately among filters 414. The selectable seat grouping filter of FIG. 7 is merely illustrative. If desired, other implementations of a seat grouping filter may be provided.

As shown in FIG. 8, seat grouping filter 417 may include an option for a user to provide a desired maximum number of seats per row. In the example of FIG. 8, filter 417 also includes a mechanism for accepting a quantity N of tickets desired by the user (e.g., using drop-down list 800). A ticket quantity can be provided within filter 417 or can be provided separately among filters 414. A user can input a maximum desired number M of seats in a given row using filter 417 (e.g., by selecting the maximum desired number from a list such as drop-down list 802, by inputting the maximum desired number using a keyboard, a finger on a touch screen, or any other suitable input device).

In response to receiving a desired quantity N and a desired maximum number M of seats in a row, a ticket server may filter the available tickets to be displayed in, for example, map 402 and list 404 of FIG. 4. For example, if a quantity of four tickets (N=4) and a maximum number of two seats per row (M=2) are received from a user, the server may highlight only venue sections having groups of seats with two adjacent rows of two seats. The example of four tickets (N=4) and two seats per row (M=2) is merely illustrative. In general, quantity N and maximum number of seats M can be any suitable integer numbers in which M is equal to or less than N.

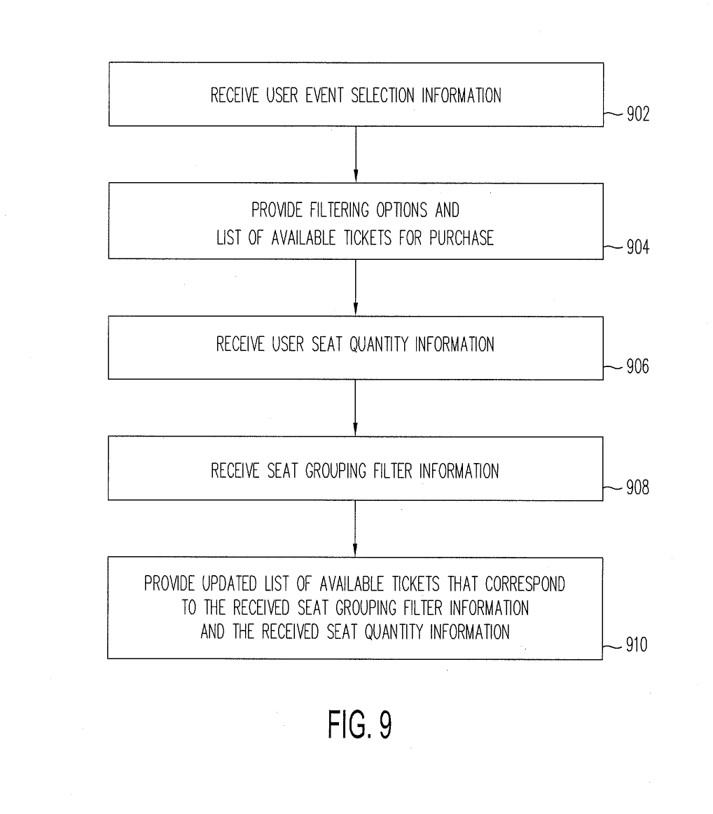

As described above, in some embodiments, a user may be provided with grouped seat selection and purchase services in the absence of a venue map. FIG. 9 is a flow chart of illustrative steps that may be used in providing grouped seat selection and purchase services without providing a venue map.

At step 902, a ticket provider such as ticket server 330 of FIG. 3 may receive user event selection information from a user device such as user device 320. The received user event selection information may be provided by the user when the user searches for and/or selects a particular event at a ticket server webpage such as website 400 of FIG. 4.

At step 904, the server may provide filtering options and list of available tickets for purchase to the user. Providing the filtering options may include providing a seat grouping filter option, other seat feature filter options, and/or other filtering options as described above in connection with filters 414 of FIG. 4.

At step 906, the server may receive user seat quantity information from the user. The user seat quantity information may be user-provided information that indicates the number of desired seats for the selected event. For example, a user may enter a desired number of seats using a keyboard, a touchscreen, voice or other data input mechanisms, or a user may select a desired number of tickets from a drop-down list of possible seat quantities. The user may also specify a range for the number of seats.

At step 908, the server may receive seat grouping filter information from the user. The seat grouping filter information may be user-provided information that indicates the desired seat grouping configuration for the user (e.g., a user request for seats in a piggyback configuration, a user request for maximum number of seats in a row, etc.). For example, a user may use website 400 to select a piggyback-only option, to enter a maximum number of seats in a given row, to enter a desired number of rows, or to otherwise choose a desired seat group configuration. Other ways to indicate or communicate a desired seat group configuration include drawing the configuration in a specifically designated area on the display. For example, the user may draw a rectangle to indicate non-staggered seats in directly adjacent rows.

At step 910, in response to the information received at step 908, the server may provide an updated list of available tickets to the user that correspond to the received seat grouping filter information and the received seat quantity information. For example, a list such as list 404 may be redisplayed listing only tickets that are in available groups of seats in a piggyback configuration. If desired, the user can initiate purchase of tickets shown in the updated list by clicking on the available tickets in the updated list. In general, the steps described above in connection with FIGS. 6 and/or 9 may be performed in any suitable order and/or combined in any suitable way for providing a potential ticket purchaser with the ability to select and purchase grouped tickets for an event.

In various embodiments, ticketed events such as the events described above can be social or recreational events, such as concerts, musicals, shows, fairs, amusement parks, sporting events and the like. Alternatively, such events can be business related events, such as business meetings, conferences, retreats, and the like.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A system for grouped seat selection for a ticketed event, comprising:
memory configured to store event information associated with the ticketed event; and
a processor coupled to the memory, wherein the processor is configured to provide a seat grouping filter option to a user, receive seat grouping filter information through the seat grouping filter option from the user, and provide a list of available tickets associated with the seat grouping filter information to the user, wherein the seat grouping filter information includes a request for seats in a piggyback configuration.

2. The system defined in claim 1, wherein the processor is further configured to provide a map of a venue for the ticketed event to the user.

3. The system defined in claim 2, wherein the processor is further configured to provide an updated map that corresponds to the received seat grouping filter information.

4. The system defined in claim 3, wherein the processor is further configured to receive user seat quantity information from the user and to provide the updated map based on the received user seat quantity information and the received seat grouping filter information.

5. The system defined in claim 1, wherein the seat grouping filter option comprises a selectable option to show only piggyback seats.

6. The system defined in claim 1, wherein the seat grouping filter option comprises an option to select a maximum number of seats per row.

7. The system defined in claim 1, wherein the piggyback configuration comprises at least one seat in each of at least two adjacent rows of seats.

8. A method, comprising:
receiving, electronically by a ticket server processor, user event selection information from a user;
providing, electronically by the ticket server processor, filtering options and a map of an event venue to the user;
receiving, electronically by the ticket server processor, user seat quantity information;
receiving, electronically by the ticket server processor, seat grouping filter information that includes a request for at least one seat in each of at least two adjacent rows of seats; and
providing, electronically by the ticket server processor, an updated map that shows available seat locations that correspond to the received seat grouping filter information and the received user seat quantity information.

9. The method defined in claim 8, further comprising:
providing a list of available tickets associated with the available seat locations in the updated map.

10. The method defined in claim 9, wherein providing the filtering options and the map of the event venue to the user comprises providing the filtering options and the map of the event venue to the user on a ticket server webpage.

11. The method defined in claim 10, wherein providing the filtering options and the map of the event venue to the user further comprises providing a seat grouping filter to the user on the ticket server webpage.

12. The method defined in claim 11, wherein providing the seat grouping filter to the user on the ticket server webpage comprises providing a selectable piggyback-only filter option to the user on the ticket server webpage.

13. The method defined in claim 11, wherein providing the seat grouping filter to the user on the ticket server webpage comprises providing a drop-down list for selecting a maximum number of seats per row.

14. The method defined in claim 8, wherein the available seat locations in the updated map correspond to groups of available tickets and wherein each group of available tickets is provided from a single ticket seller.

15. The method defined in claim 8, wherein the available seat locations in the updated map correspond to groups of available tickets and wherein at least one group of available tickets includes tickets that are provided from more than one ticket seller.

16. A non-transitory machine-readable medium having a plurality of machine-readable instructions which, when executed by one or more processors of a server, are adapted to cause the server to perform a method comprising:
receiving a request for a group of seats in a piggyback configuration for an event at a venue; and
in response to receiving the request, displaying available tickets for available seats at the venue that match the piggyback configuration.

17. The non-transitory machine-readable medium defined in claim 16, wherein the piggyback configuration includes seats in a plurality of adjacent rows of seats.

18. The non-transitory machine-readable medium defined in claim 16, wherein the method further comprises:
in response to receiving the request, displaying a map that indicates sections of seats at the venue that include the available seats at the venue that match the piggyback configuration.

19. The non-transitory machine-readable medium defined in claim 16, wherein the method further comprises:
providing filtering options that include a seat grouping filter.

20. The non-transitory machine-readable medium defined in claim 19, wherein the seat grouping filter includes a selectable option for piggyback-only seat configurations.
